(19) United States
(12) Patent Application Publication
(10) Pub. No.: US 2008/0030516 A1
(43) Pub. Date: Feb. 7, 2008

(54) Electronic presentation system and method

(76) Inventors: Roshanak Haghighat Haghighi, (US); Keyvan Haghighat Haghighi, (US); Kourosh Salehi, New York, NY (US)

Correspondence Address: Kourosh Salehi, Apt. 2A, 337 East 50th Street, New York, NY, 10022, US

(21) Appl. No.: 11/784,093

(22) Filed: Apr. 5, 2007

Related U.S. Application Data
(60) Provisional application No. 60/789,256, filed on Apr. 5, 2006.

(51) Int. Cl. G09G 5/00; G07F 7/00; G06T 1/00

(52) U.S. Cl. 345/581; 345/418; 705/27

(57) ABSTRACT

A presentation system that includes a first image file containing computer readable information representing a first image and a second image file containing a plurality second image files each containing computer readable information representing a second image, and computer readable instructions for selectively superimposing each second image file onto the first image file and computer readable instructions for normalizing a selected second image to the first image.

### RELATED APPLICATION

The present application claims priority to U.S. Provisional Application Ser. No. 60/789,256, entitled Electronic Presentation System and Method & Loudspeaker, Kourosh Salehi, et al., filed on Apr. 5, 2006, the entire disclosure of which is incorporated by reference.

### FIELD OF THE INVENTION

The present invention relates to a presentation system.

### BACKGROUND OF THE INVENTION

In the recent years, online shopping has been growing to a very stable business particularly for articles that do not require individualization. For example, electronic gadgets and equipment have found the world wide web to be a great marketplace. One reason for the successful commercialization of such articles is that the information that is necessary to satisfy the online buyer can be readily published. For example, an online buyer of an MP3 player can obtain information regarding the features of an MP3, its price, its appearance, its size and the like without having to actually see or feel the device.

An article which has to primarily satisfy the individual subjective preferences of the online buyer, however, may be more difficult to commercialize in the online marketplace. An example of such an article are prescription or non-prescription glasses. To elaborate, the frames of glasses can normally accommodate any type of lens. Thus, all frames are essentially functionally equivalent. However, a substantial portion of the value of a frame for a user is how the frame looks when worn. Thus, in a conventional market place, retail stores allow a purchaser to wear the glasses in order to satisfy his/her subjective tastes and preferences before making a purchase. In the online marketplace the opportunity to try a frame on in order to examine its look when worn has not yet been realized.

Currently, online retailer allow the buyer to order a frame. The frame is then sent to the buyer by mail or the like so that the buyer may try the frame on at home. If dissatisfied after trying the frame on, the buyer can then return the frame back to the online seller. Such a transaction is complex compared to the conventional method of selling frames in a retail store, time consuming and expensive.

Another method for assisting the online buyer involves modeling the frames for the buyer. In this method, the buyer is directed to choose a shape that the buyer deems to be closest to the shape of his or her face. Thus, for example, a buyer is given a choice between oval, circular, etc. Once, the shape is selected, a model's face is shown with the chosen frame in order to suggest how the chosen frame may look on the buyer's face. This method obviously does not allow the buyer to examine the frame on his or her own face for its looks or its relative scale. Regarding the latter, while the frame may look well proportioned relative to the model's face, it may in fact be too small or too large for the buyer's face.

### SUMMARY OF THE INVENTION

The present invention relates to a presentation system and application that allows a user to examine an article for its appearance in an online environment.

A presentation system according to the present invention includes a first computer readable and displayable first electronic image file containing a single first image; and a plurality of second computer readable files each containing computer readable data for the display of a second image, each second image being an image of the same item, when displayed on a computer display, being positioned on a common plane, and each second image being angularly displaced about an axis normal to the common plane with respect to the other images and capable of superimposition on the first electronic image when displayed; and computer readable instructions to enable the selection of the second electronic images from the plurality of the second electronic images.

A system according to the present invention further includes computer readable instructions for normalizing the first image and the selected second image to a common scale such that the combination of the images are rendered in the same scale.

In the preferred embodiment, the first electronic image file is an image of the user's face when displayed on a computer monitor and the second images are images of a pair of glasses when displayed on a computer monitor.

In a method according to the present invention, the second computer readable file is prepared by taking electronic images of the single item by, placing the item on a rotatable platform; rotating the platform multiple times; and taking an electronic image of the article from the same position each time the platform is rotated. Alternatively, the second computer readable file is prepared by collecting electronic images of the single item through the following method, placing the item on a platform; and taking multiple electronic images of the item from different angles.

According to an aspect of the present invention a reference line is used to orient the second image with respect to horizon. Furthermore, the length of a reference line is used to normalize the first image and the second image.

The preferred embodiment of the present invention relates to a presentation system and an application that allows an online buyer to try a pair of frames or sunglasses in an online environment in order to examine the looks thereof. In the context of prescription glassses, other than allowing a user to try on the glasses, a presentation system according to the present invention would allow a user to examine the look of the glasses without blurring. Specifically, when a buyer visits an optician's store to try on glasses, he may have to remove his/her glasses first. Thus, when the buyer tries on a new frame he may only see a blurred image of himself given that conventionally frames are provided without prescription lenses. The present invention allows the user to avoid the blurring problem.

Furthermore, in a conventional environment a user must remove the frame before trying on another frame. Thus, a user will have to rely on his/her memory for comparison of the look of the frames. The present invention allows the user to make side by side comparison of multiple frames.

Other features and advantages of the present invention will become apparent from the following description of the invention which refers to the accompanying figures.

### BRIEF DESCRIPTION OF THE FIGURES

FIG. 1 illustrates schematically a network of computers that enable a system according to an embodiment of the present invention.

FIG. 2 shows an example of a presentation area generated by an embodiment of the present invention prior to loading a first image.

FIG. 3 shows an example of the presentation area after loading a first image.

FIG. 4 shows an example of the presentation area after loading a second image and superimposing the same on the first image.

FIG. 5 shows an example of the presentation area after adjusting the orientation of the second image.

FIG. 6A shows a top plan view of an article placed on a rotatable platform.

FIG. 6B shows an image of the article illustrated in FIG. 6A taken by a digital camera in a static position.

FIGS. 7A shows a top plan view of the article placed on the rotatable platform that is angularly displaced relative to its previous position (FIG. 6A) in a counterclockwise direction.

FIG. 7B shows an image of the article illustrated in FIG. 7A taken by the digital camera in its static position.

FIG. 8A shows a top plan view of the article placed on the rotatable platform that is further rotated relative to its previous position (FIG. 7A) in a counterclockwise direction.

FIG. 8B shows an image of the article illustrated in FIG. 8A taken by the digital camera in its static position.

FIG. 9A shows a top plan view of the article placed on the rotatable platform that is further rotated relative to its previous position (FIG. 8A) in a counterclockwise direction.

FIG. 9B shows an image of the article illustrated in FIG. 8A taken by the digital camera in its static position.

FIGS. 10A-10F illustrate further images of the article in other orientations.

FIG. 11 illustrates an example of an input box for receiving data related to the normalization feature of the present invention.

FIG. 12 illustrates a flow chart for a process according to an embodiment of the present invention.

### DETAILED DESCRIPTION OF THE INVENTION

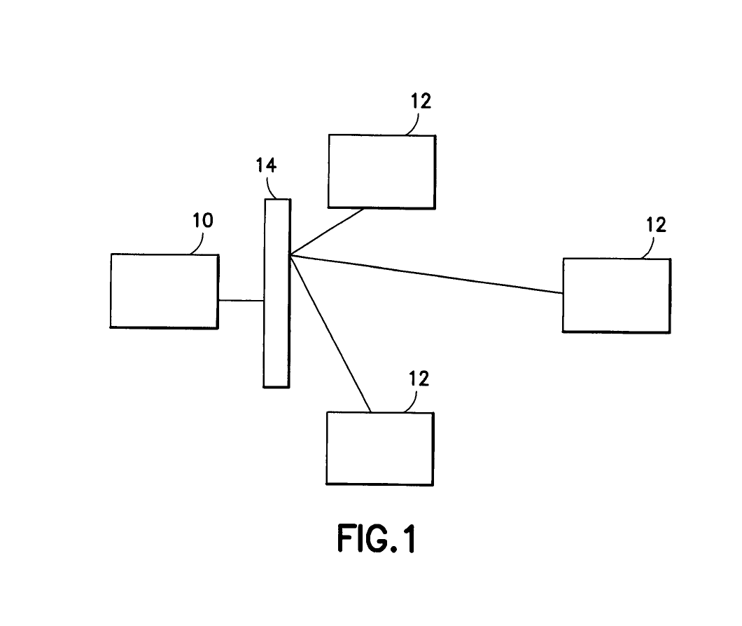

Referring to FIG. 1, a presentation system according to the present invention includes a plurality of computer readable instructions and computer readable data that reside preferably in the permanent or temporary memory of one or a plurality of interconnected network of computers 14, e.g. a publicly accessible network such as the Internet or a private local or wide area network. At least one of the computers is a client computer 12 which is in operative communication with the network whereby it is capable of sending and receiving computer readable files containing computer readable data and instructions (programs) from, for example, a server computer 10. The client computer may be an ordinary PC that includes all the usual peripheral equipment including a monitor (preferably capable of displaying colored images), a keyboard, internal solid state memory (temporary or permanent), a central processing unit, and the like found in an ordinary PC that enable computer readable data and/or instructions to be permanently or temporarily stored for the purpose of displaying images on the monitor, and executing computer readable instructions.

It should be noted that a presentation system according to the present invention is not restricted to a network of computers, but may be limited to a single stand alone computer, such as a PC.

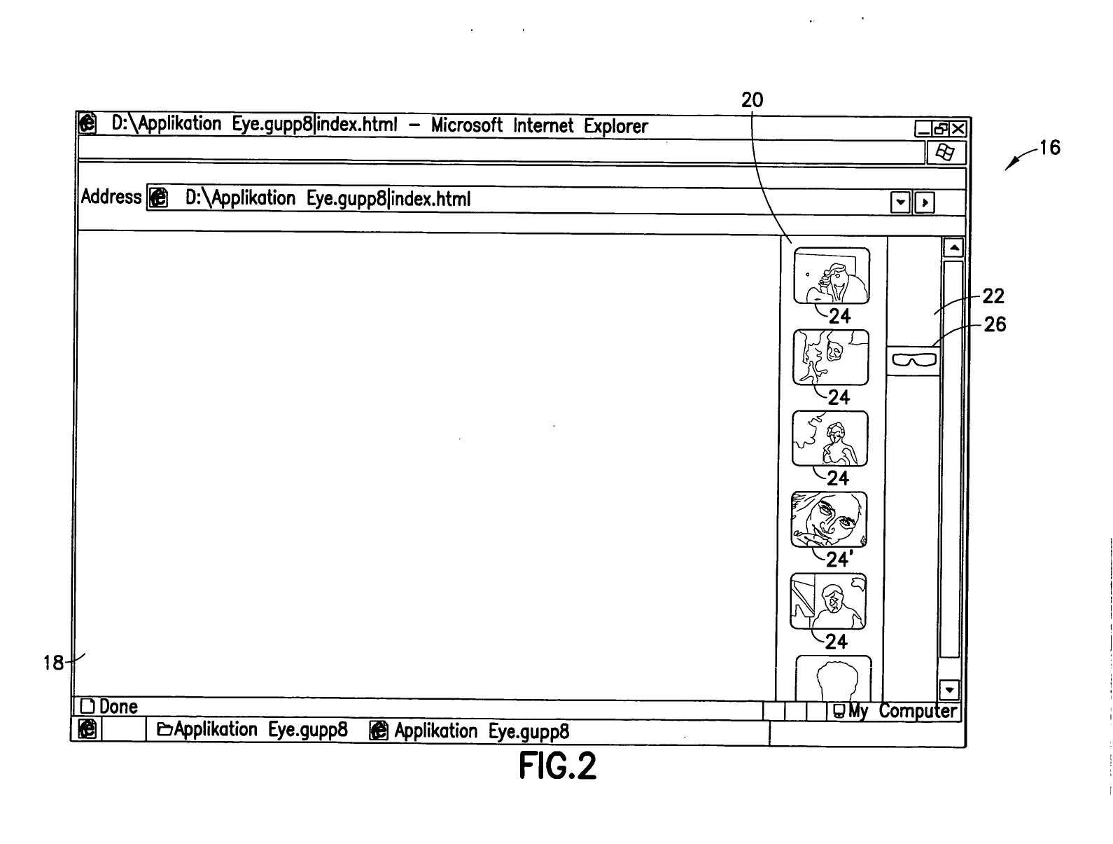

Referring to FIG. 2, a system according to the present invention includes computer readable instructions and data for displaying a display panel 16. Display panel 16 includes preferably a presentation area 18 and a first selection area 20 and second selection area 22. First selection area 20 displays at least one first image 24, but is preferably capable of displaying a plurality of images. The first image 24 is displayed by reference to a first image file preferably resident on a permanent or temporary memory of client computer in any computer readable format. A preferred format is JPG.

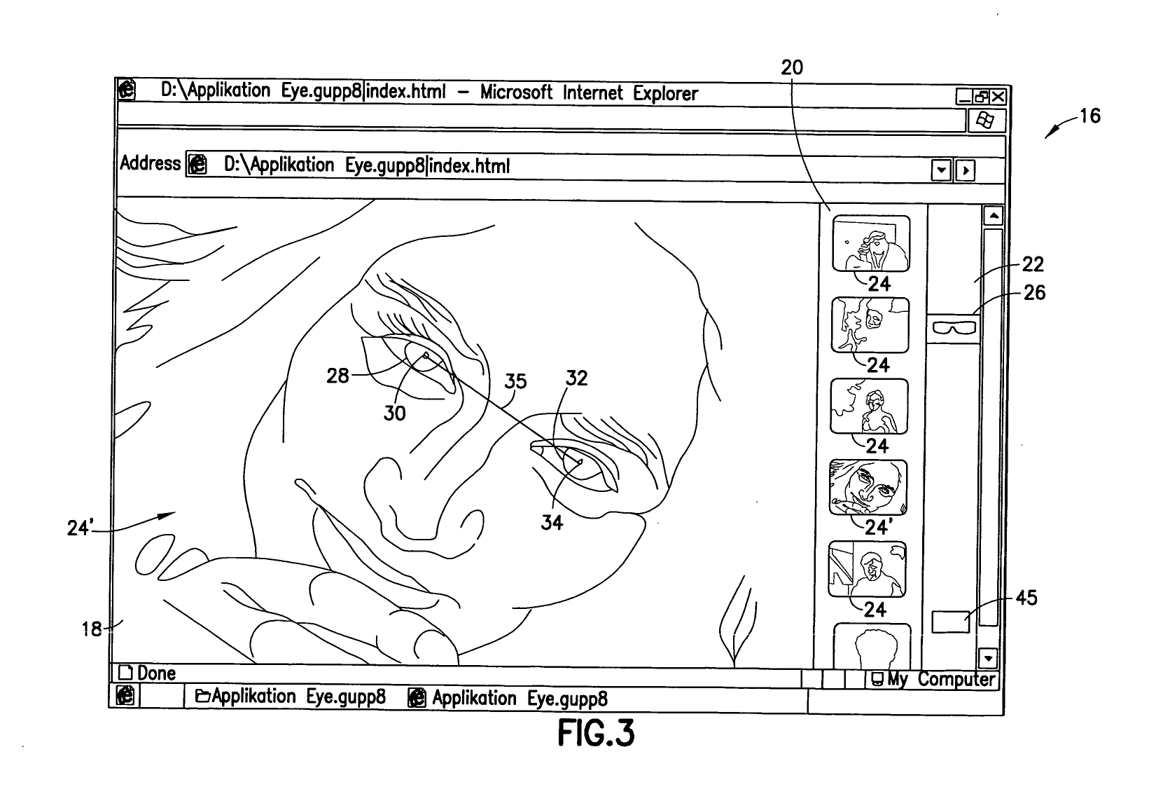

A system according to the present invention includes computer readable instructions that enable a user to select and display any one of the first images 24 in presentation area 18. Specifically, for example, the computer readable instructions enable the user to place the cursor on a first image 24′ and click whereby the first image 24′ is selected and displayed in the presentation area 18 as seen in FIG. 3. Note that as a result the first image 24′ is preferably enlarged to fill the entire presentation area 18.

Second selection 22 area also displays at least one second image 26. The second image 26 is displayed by reference to a second image file preferably resident on a permanent or temporary memory of a client computer 12 in any computer readable format, e.g. the JPG format.

A presentation system according to the present invention includes a plurality of second image files each containing computer readable data for the purpose of displaying a second image 26. Each second image 26, when displayed on a computer monitor, is an image of the same item on a common plane but viewed from a different angle. Specifically, each second image 26 is an image of the same item which is angularly displaced relative to the other images but disposed on a common plane when displayed, for example, by a computer monitor.

A system according to the present invention includes computer readable instructions that enable the selection and the superimposition of a second image 26 onto a selected first image 24′. In addition, a system according to the present invention includes computer readable instructions that enable a user to orient a selected second image 26 relative to the selected first image 24′, whereby a combined image is displayed.

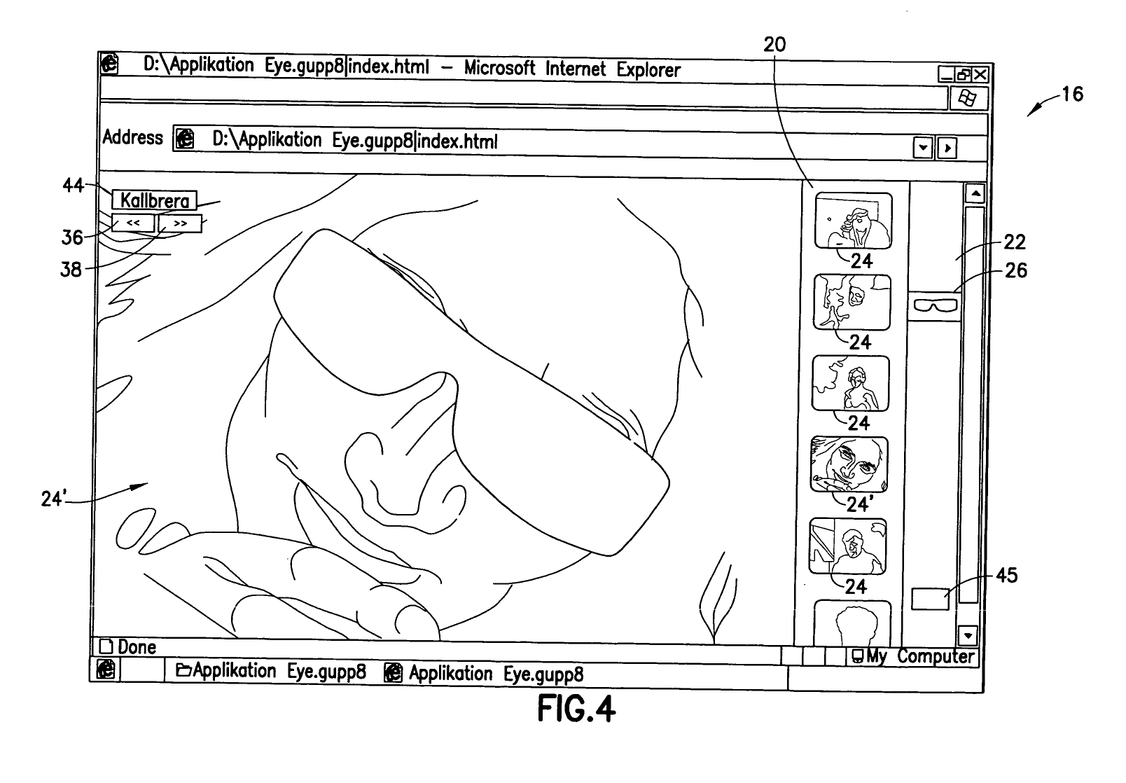

In the preferred embodiment, to orient a second image 26 relative to the first image 24′ a reference line 35 is first established. Referring to FIG. 3, in which selected first image 24′ is the image of a person's face, the reference line 35 can be established by pointing the cursor at the center (or near the center) of the right eye 28 followed by a click to establish the first reference point 30. Then the cursor is pointed at the center of the left eye 32 followed by a click to establish a second reference point 34. The computer then interprets the line that intersects the first reference point 30 and the second reference point 34 as a reference line. Next, a second image 26 is selected by pointing the cursor at a second image 26 and clicking. Upon clicking, the selected second image 26 is superimposed onto the selected first image 24 in alignment with the reference line 35. Specifically, the second image 26 is superimposed onto the first image 24′ such that the reference line 35 and the common plane on which second image resides are parallel to one another. The result of the superimposition as described are shown by FIG. 4.

Note that the selected and superimposed second image 26 (which in the embodiment shown is an image of a pair of sunglasses) is not perfectly aligned with the first image 24′. To obtain a combined image in which the first image 24′ and the second image 26 are perfectly aligned to one another a system according to the present invention includes computer readable instructions that allow the user to select another second image that is angularly displaced with respect to the first selected image until a proper match between the first image 24′ and the second image 26 is obtained. Specifically, in the preferred embodiment two orientation selection buttons 36, 38 are provided. First orientation selection button 38 allows for the selection of a second image that is angularly displaced in a counter-clockwise direction with the respect to the first selected second image. The second orientation selection button 36 allows for the selection of a second image 26 that is angularly displaced in a clockwise direction with respect to the first selected second image 24′. To illustrate, by pointing the cursor at the first orientation selection button 38 and clicking another second image 26 is selected which is angularly displaced in a counter-clockwise direction with respect to the first selected second image. The second selected image is superimposed in the same manner as the first second image. That is, the second selected image is superimposed such that the common plane is parallel to the reference line 35. However, due to its angular displacement relative to the first selected second image, the orientation of the second selected image is better matched with the orientation of the first image. Thus, as seen in FIG. 5, the orientation of the selected first image and the second selected image appear to match. Note that, if the second selected second image is not oriented properly the third, the forth, the fifth, or more images can be selected and superimposed until the orientation of the selected first 24′ and the selected second image 26 can be matched.

The operation of second orientation selection button 36 is the same as that of first orientation selection button 38 except that it enables the user to select second images that are angularly displaced with respect to the first selected second image in the clockwise direction.

To enable a presentation system according to the present invention the second images 26 must be prepared to be in computer readable format. A desirable and preferred format is the JPG format. The second images 26 may be prepared using an ordinary digital camera according to the following method.

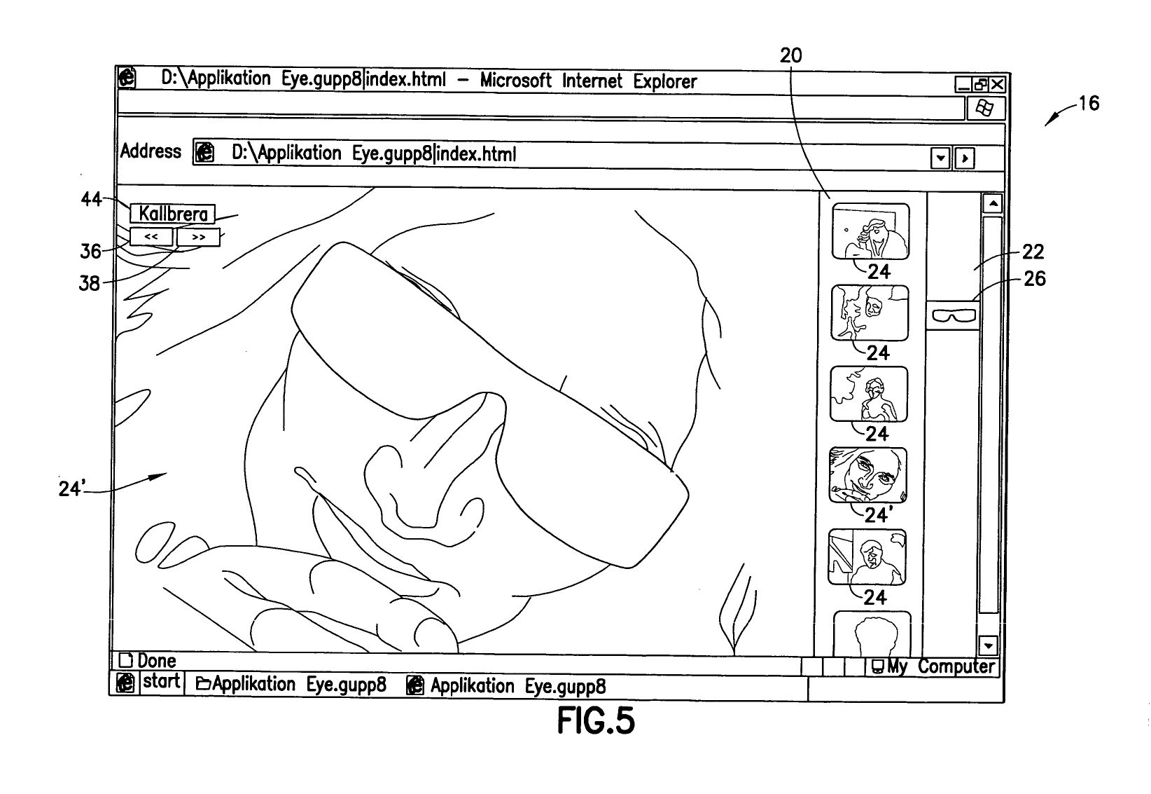

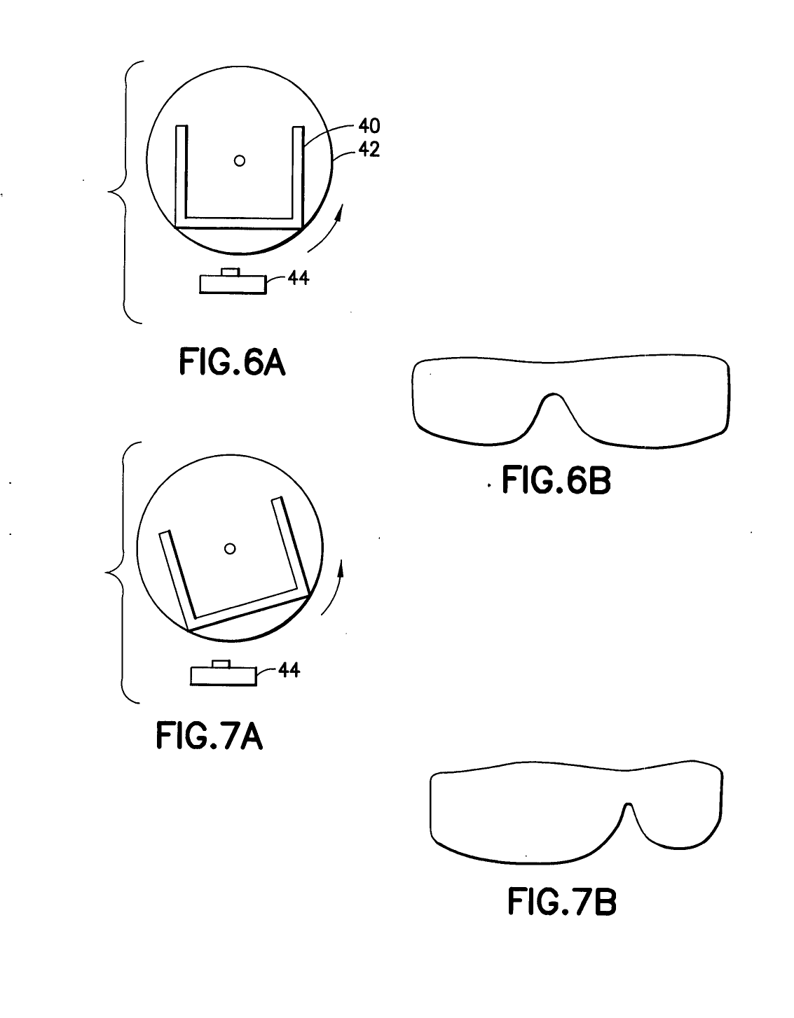

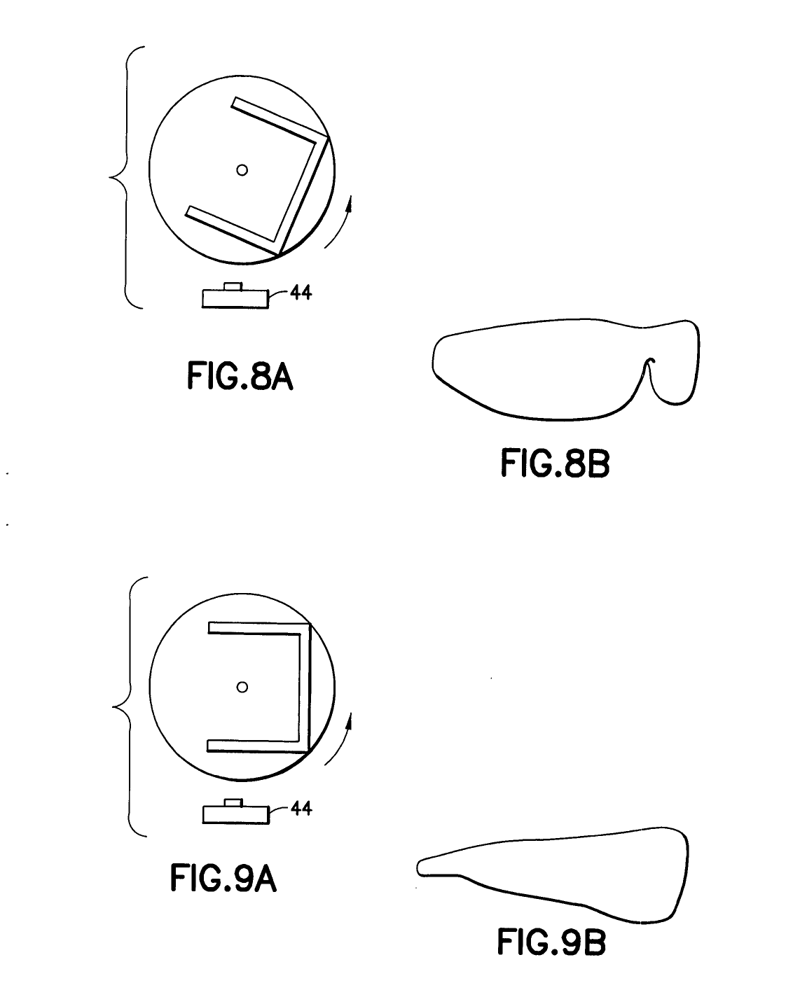

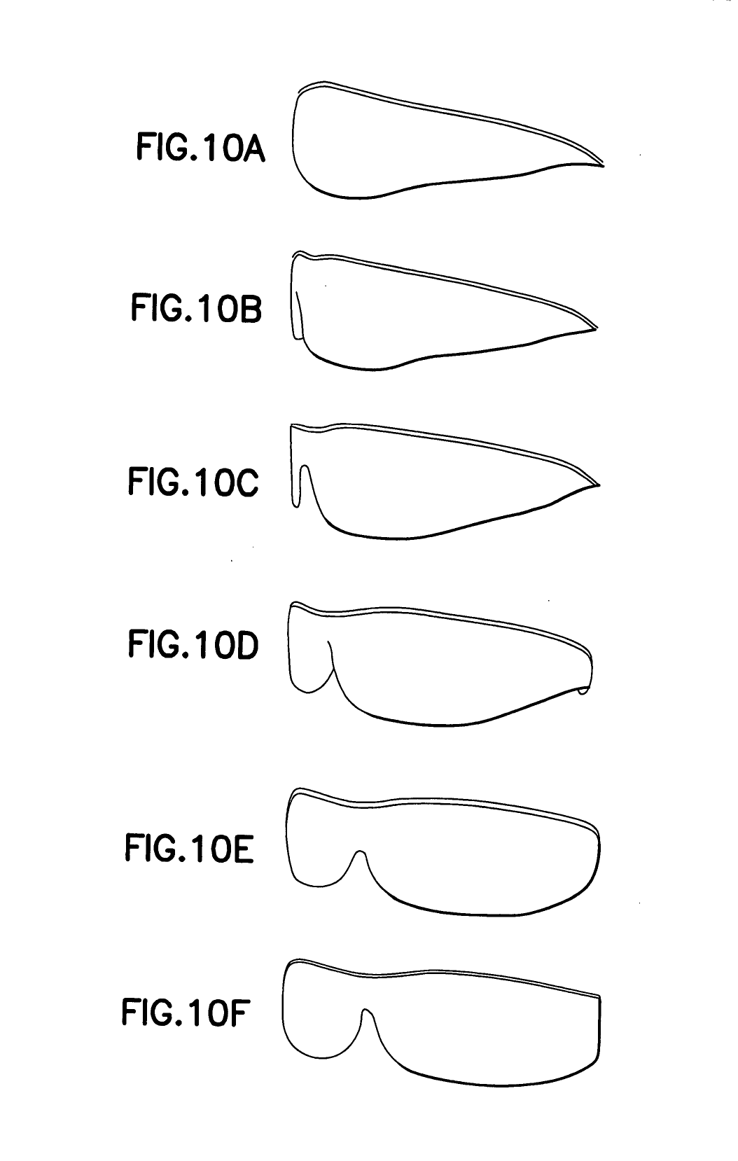

Referring to FIG. 6A, an article 40, which is to be the subject of second images 26, is placed on a rotatable platform 42. For example, a pair of sunglasses is placed on the platform 42. Note that the platform will be the common plane on which second images are residing. A camera is then positioned in placed to take a second image 26. The second image 26 taken in the orientation illustrated by FIG. 6A is shown by FIG. 6B. Next, the platform 42 is rotated (either clockwise or counter-clockwise) as illustrated by FIG. 7A and another second image 26 is taken. The second image taken in the orientation illustrated by FIG. 7A is shown by FIG. 7B. FIGS. 8A and 9A illustrated two other orientations obtained by further rotating platform 42. FIGS. 8B and 9B illustrate the second images 26 obtained by each rotation respectively. This process can be repeated as many times as is desired. The angular displacement between second images 26 is not critical, but it is understood that to obtain better orientation adjustment the angular displacement between the second images should be closely spaced. In addition, the second images 26 can be obtained by rotating platform 42 in the clockwise or counter-clockwise direction without deviating from the scope of the present invention. FIGS. 10A-10F illustrate further second images in other angular orienations.

According to another method, a three dimensional scanner can be used to obtain second images in angularly displaced orientation.

According to yet another method a 3-D computer aided design (CAD) program that is used to design the eyeglass frame can be used for providing the second images. Specifically, the output of the 3-D program which constitutes an electronic image of the eyeglass frame can be used to generate a series of images necessary for the second images. Programs such as 3d Studio Max can then be used to render the 3d models obtained from the 3-D CAD program into jpeg or PNG formats for use in a system according to the present invention.

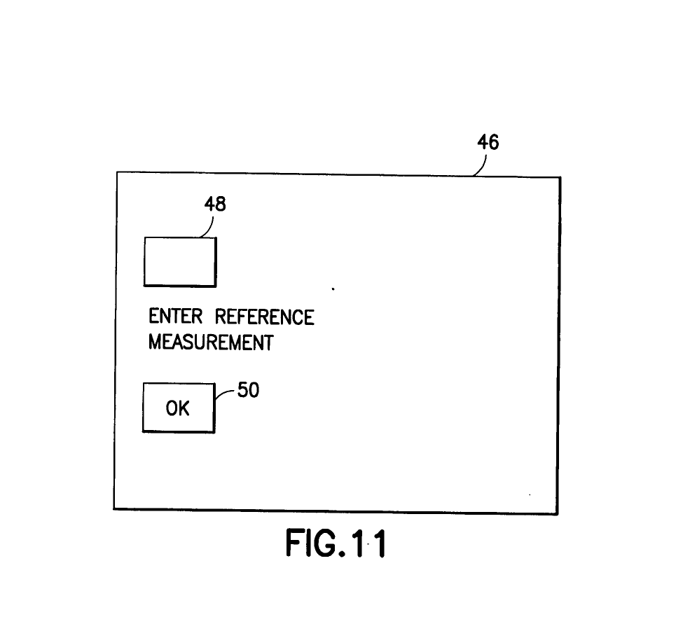

It should be noted that to have as realistic a presentation as possible the first image 24′ and the second image 26 should be displayed in the same scale. According to the present invention, the first selected image 24′ and the second selected image 26 are normalized. By normalized, it is meant that the first selected image 24′ and the second selected image 26 are fitted to a common scale. To perform normalization according to the present invention a reference measurement is required. In the preferred embodiment, the length of the reference line 35 is used as a reference measurement in the normalization function. Thus, referring to FIG. 3, in the preferred embodiment, a normalization button 45 is provided. By pointing the cursor at normalization button 45 and clicking a window is opened such as the one seen in FIG. 11. FIG. 11 includes an input box 48 and instructions for the entry of a reference measurement to which the first image 24′ and the second image 26 are normalized. Thus, for example, a reference measurement is entered into input box 48 and OK button is clicked. A system according to the present invention would include computer readable instructions which use the measurement from input box 48 and rescales the second image 26 to the first image 24′. That is, the actual size of the item represented in the second image is used to rescale the second image 26 so that the first image 24′ and the second image 26 which is superimposed on the first image 24′ are displayed in the same scale.

In the first embodiment of the present invention the first image 24 is that of an image of a person's face, and the second images 26 are images of a pair of sunglasses. Alternatively, the second images 26 may be images of an ordinary pair of glasses. The reference measurement input in a system according to the preferred embodiment may be the popular distance (PD) which is the distance between the center of the pupils of a person, and is used by opticians and the like for the purpose of fabricating lenses. The PD can also be used, in the preferred embodiment, to rescale the selected second image 26 to the first image 24′ so that a realistic image can be obtained when the second selected image 26 is superimposed onto the first image 24′.

It should be noted that in other embodiments the reference measurement can be input independent of reference line. Thus, for example, an alternative system may allow the user to generate a normalization reference line (for example, using the same method as that set forth above for the generation of orientation reference line) and input a measurement for the normalization reference line. The input can then be used to normalize the selected first image 24′ and the selected second image 26.

For example, in a system according to the second embodiment the first image 24 may be that of a room, and the second image 26 may be that of a piece of furniture. In such a case, a normalization reference line can be generated and by clicking two reference points on the first image, and inputting a measurement for the distance between the two reference points. This measurement is then used to normalize the first and the second images.

Set forth below are a set of computer readable instructions for a third embodiment of the present invention. In this embodiment, no second image file is shown in the display area. Rather, after second reference point is selected a second image is automatically superimposed on the first image. The second image so superimposed can then be replaced with another one until the orientation of first selected image and second selected image are matched. The program set froth below is edified in Macromedia Flash and Macromedia Dreamweaver. The editing and the illustrations to obtain the images in the second image file have been realized in Adobe Photoshop. The program performs in a web browser, where a user/costumer, has the opportunity to download his/her own image. As soon as the user's image is downloaded the user will be able to see it on the browser. Note that the second images that are taken from different angles are stored in a layer and in different several motion twins in the program Macromedia Flash MX.

Actions for Frame 1 of layer Name layer 1

```
myListener = new Object( );
MosuISDown = false;
eye2._visible = false;
_global.Calib = 2;
OnKalibrera( );
eye2.stop( );
x1 = −1;
x2 = −1;
y1 = −1;
y2 = −1;
myListener.onMouseMove = function( ) {
  if (MosuISDown) {
    eye2._x = _xmouse;
    eye2._y = _ymouse;
  }
};
function abs(x) {
  return Math.abs(x);
}
function DoCalib( ) {
  xx = x1−x2;
  yy = y1−y2;
  zz = Math.sqrt(xx*xx+yy*yy);
  eye2._xscale = zz/2.14;
  eye2._yscale = zz/2.14;
  eye2._visible = true;
  kalibButton._visible = true;
  anvisningar._visible = false;
  BK1._visible = false;
  eye2._y = (y1+y2)/2−0.25*eye2._yscale;
  eye2._x = (x1+x2)/2;
  rotR._visible = true;
  rotL._visible = true;
  eye2._rotation = Math.atan2(yy, xx)*180/Math.PI;
}
myListener.onMouseDown = function( ) {
  if (_global.Calib == 2) {
    x2 = _xmouse;
    y2 = _ymouse;
    _global.Calib = 1;
  } else if (_global.Calib == 1) {
    x1 = _xmouse;
    y1 = _ymouse;
    _global.Calib = 0;
    DoCalib( );
  }
  if (abs(eye2._x−_xmouse)<=100 && abs(eye2._y−_ymouse)<=50) {
    MosuISDown = true;
  }
};
myListener.onMouseUp = function( ) {
  MosuISDown = false;
};
myListener.onKeyDown = function( ) {
  switch (Key.getCode( )) {
  case 37 :
    // Right
    eye2._x = eye2._x−1;
    break;
  case 38 :
    // UPP
    eye2._y = eye2._y−1;
    break;
  case 39 :
    // left
    eye2._x = eye2._x+1;
    break;
  case 40 :
    // DN
    eye2._y = eye2._y+1;
    break;
  default :
    trace(Key.getCode( ));
  }
};
myListener.onKeyUp = function( ) {
};
function OnOk( ) {
  eye2._x = −400;
  eye2._y = −400;
}
Key.addListener(myListener);
Mouse.addListener(myListener);
function OnKalibrera( ) {
  MosuISDown = false;
  eye2._visible = false;
  _global.Calib = 2;
  kalibButton._visible = false;
  anvisningar._visible = true;
  BK1._x = 0;
  BK1._y = 0;
  BK1._width = 10000;
  BK1._height = 10000;
  BK1._visible = true;
  rotR._visible = false;
  rotL._visible = false;
}
function OnRotR( ) {
  eye2.gotoAndStop(eye2._currentframe+1);
}
function OnRotL( ) {
  eye2.gotoAndStop(eye2._currentframe−1);
}
```

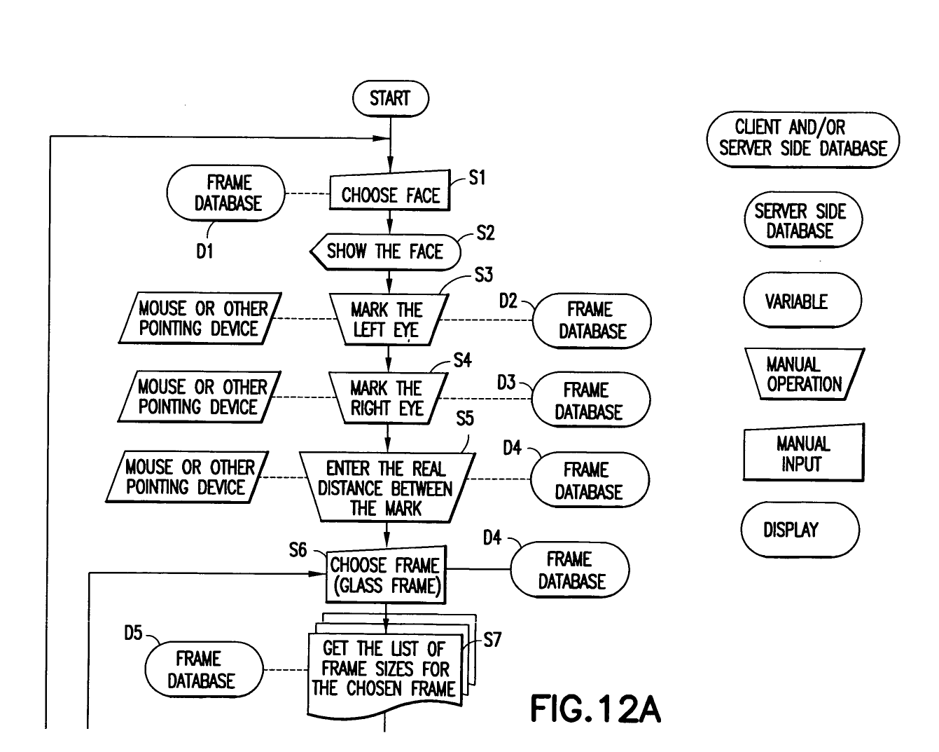

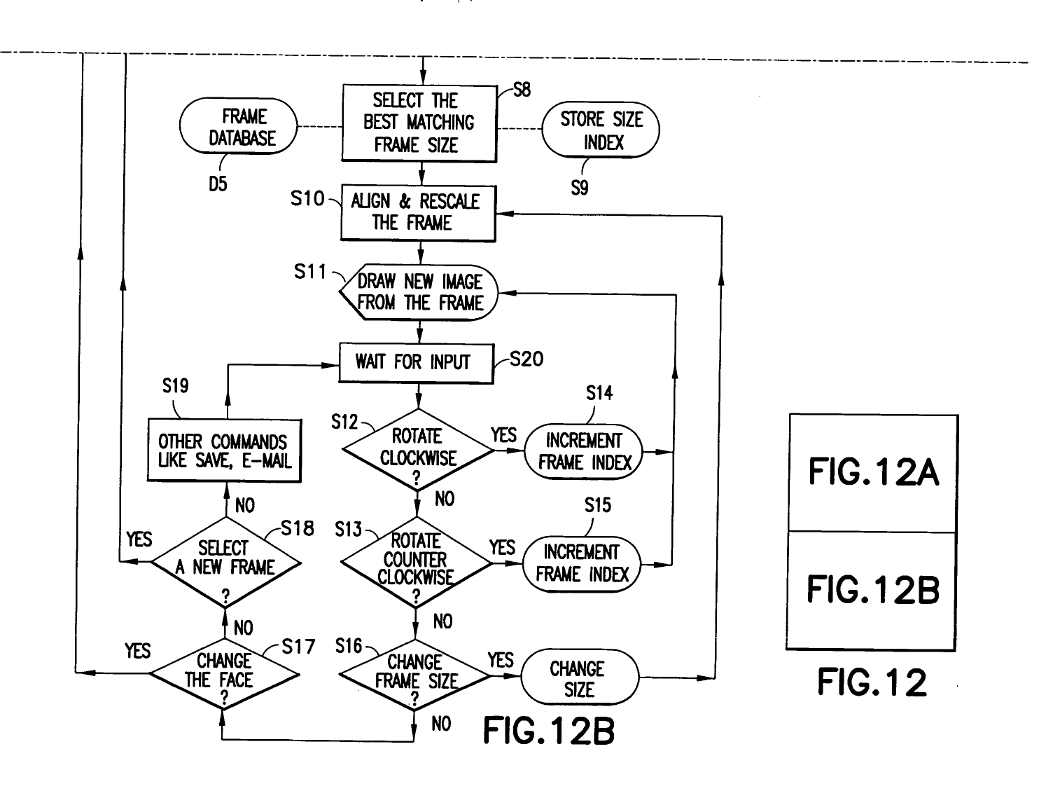

Referring to FIG. 12, which illustrates a flow chart related to an embodiment of the present invention, the following steps take place to superimpose one image onto another according to the present invention. First, a user selects S1 the image of a face (first image 24′) from a Face Database D1 containing at least one electronic image of a face of a person. Once the image of a face is selected it is displayed S2. Thereafter, the left eye in the image is selected (clicked) S3 using a pointing device such as a mouse, and then the right eye in the image is selected (clicked) S4 using a pointing device such as a mouse. Note that each selected location in S3, and S4 constitutes a reference mark or point 30,32. Note further that S3 and S4 can be carried out in the sequence S4 and then S3 without deviating from the scope and the spirit of the present invention. The coordinates of the marks in each step S3, S4 are stored D2, D3 in respective locations in an electronic memory storage of, for example, a client 12 computer. Then, the real distance between the marks is entered by a user S5, and stored in a related electronic memory location D4. Next, an image file containing a plurality of images of a frame (second images 26) is selected S6 by the user, which results in getting a list of frame sizes for the chosen frame S7 and selecting the best matching frame size S8 to the distance between the marks from a Frame Database D5. Note that in step S6 an image of glasses is selected according to a predetermined orientation, which may referred to as zero index. For example, an image file containing the image shown in FIG. 6B is selected as the first image of glasses to be superimposed on the image of the face. The index of the best matching frame size is then stored S9 in an electronic memory location. The image of the selected frame is then aligned and rescaled to the displayed face image S10 and the frame is drawn (i.e. superimposed) on the image of the face using the frame and the size index S11. At this stage, a second image (an image of the selected frame) is superimposed on the first image (the image of the face). The program is now ready to take input from the user in order to adjust the orientation of the image of the frame to the orientation of the image of the face. Thus, an image of the frame that is rotated clockwise S12 relative to the selected image of the frame, or counterclockwise S13 relative to the selected image of the frame can be selected by incrementing the frame index S14,S15, which result in drawing the newly selected image of the frame in step S11. The incrementing steps can be continued until the user is satisfied with the orientation of the frame image relative to the image of the face.

Furthermore, if the user is dissatisfied with the frame size that is selected the user may select another frame size S16 which then returns the program to step S10. Alternatively, the user can change the image of the face S17, which returns the program to steps S1, select a new frame image S18 which returns the program to S6, or the user can access other facilities such as permanent storage for later retrieval, e-mail or the like S19, which then returns the program to S20 to wait for the user's input.

Although the present invention has been described in relation to particular embodiments thereof, many other variations and modifications and other uses will become apparent to those skilled in the art. It is preferred, therefore, that the present invention be limited not by the disclosure herein, but only by the appended claims.

1. A presentation system comprising:
a first computer readable and displayable first electronic image file containing a single first image; and
a plurality of second computer readable files each containing computer readable data for the display of a second image, each second image being an image of the same item, when displayed on a computer display, being positioned on a common plane, and each second image being angularly displaced about an axis normal to said common plane with respect to the other images and capable of superimposition on said first electronic image when displayed; and
computer readable instructions to enable the selection of said second electronic images from said plurality of said second electronic images.

2. A presentation system according to claim 1, further comprising computer readable instructions to enable the superimposition said selected second electronic image file.

3. A presentation system according to claim 1, further comprising computer readable instructions for normalizing said first image and said selected second image to a common scale.

4. A presentation system according to claim 1, wherein said first computer readable file is in JPG format.

5. A presentation system according to claim 1, wherein said second electronic images are in JPG format.

6. A presentation system according to claim 1, wherein said first electronic image file is an image of a person's face when displayed on a computer monitor.

7. A presentation system according to claim 1, wherein said second images are images of a pair of glasses when displayed on a computer monitor.

8. A presentation system according to claim 1, wherein said second images are images of a pair of sunglasses when displayed on a computer monitor.

9. A presentation system according to claim 1, wherein said first electronic image file is an image of a room when displayed on a computer monitor.

10. A presentation system according to claim 1, wherein said second images are images of furniture when displayed on a computer monitor.

11. A presentation system according to claim 1, wherein said second computer readable file is prepared by taking electronic images of said single item by,
placing said item on a rotatable platform;
rotating said platform multiple times; and
taking an electronic image of said article from the same position each time said platform is rotated.

12. A presentation system according to claim 1, wherein said second computer readable file is prepared by collecting electronic images of said single item through the following method,
placing said item on a platform; and
taking multiple electronic images of said item from different angles.

13. A presentation system according to claim 1, wherein a reference line is used to orient said second image with respect to horizon.

14. A presentation system according to claim 1, wherein the length of a reference line is used to normalize said first image and said second image.

15. A presentation system according to claim 1, wherein said first computer readable and displayable first electronic image file; said second computer readable file, and said instructions reside on a computer network.
